(19) United States
(12) Patent Application Publication
(10) Pub. No.: US 2003/0144837 A1
(43) Pub. Date: Jul. 31, 2003

(54) Collaboration of multiple automatic speech recognition (ASR) systems

(76) Inventors: Sara H. Basson, White Plains, NY (US); Dimitri Kanevsky, Ossining, NY (US); Emmanuel Yashchin, Yorktown Heights, NY (US)

Correspondence Address: McGuireWoods LLP, Suite 1800, 1750 Tysons Boulevard, McLean, VA, 22102-3915, US

(21) Appl. No.: 10/058,143

(22) Filed: Jan. 29, 2002

(51) Int. Cl. G10L 15/00

(52) U.S. Cl. 704/231

(57) ABSTRACT

A system and method for collaborating multiple ASR (automatic speech recognition) systems. The system and method analyzes voice data on various computers having speech recognition residing thereon. The speech recognition residing on the various computers may be different systems. The speech recognition systems detect voice data and recognize their respective masters. The master computer as well as those computers which did not recognize their master may analyze the voice data (evaluate) and then integrate this analyzed voice data into a single decoded output. In this manner, many different speakers, utilizing the system and method for collaborating multiple ASR systems, may have their voice data analyzed and integrated into a single decoded output, regardless of ASR systems.

### BACKGROUND OF THE INVENTION

1. Field of the Invention

The present invention generally relates to speech recognition systems and, more particularly, to a system and method for collaborating multiple ASR (automatic speech recognition) systems.

2. Background Description

The transcription of meetings and other events such as, for example, court hearings and other official meetings and the like, is a very important application. At present, the transcription of meetings is performed either through stenography or simply voice recording. In the latter application, a stenographer or other person may transcribe the contents of the recording at a later time. A person may also take notes during the meeting in order to record the main or salient points of the meeting. Of course, the use of notes only has limited applications since it cannot be used during court proceedings or other official hearings.

None of the above methods are ideal. For example, a stenographer may not be available or may be too expensive. A summary of a meeting or discussion, on the other hand, may miss important details or be misinterpreted at a later time due to incomplete or inaccurate notes. The notes of the meeting may also be taken out of context thus rendering a different meaning to the relevant portions of the meeting. Voice recordings, which are later transcribed, may not be useful in court hearings and other official proceedings due to very stringent rules concerning the recording of such events.

The use of speech recognition has also been utilized to record meetings and the like. However, speech recognition software is typically trained for an individual speaker. Thus, several people speaking at a meeting would cause a very high error rate. A summary based on text collected by speech recognition is also difficult. To use speech recognition, it is necessary to create protocols of many meetings. But, creating manual protocols is expensive and not always available. Also, individual automatic speech recognition (ASR) systems do not have sufficient quality to provide the protocols.

### SUMMARY OF THE INVENTION

According to a first aspect of the invention,

According to a second aspect of the invention,

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an overview of a system implementing the present invention;

FIG. 2 shows a system diagram of the present invention;

FIG. 3 shows the composition of a computer (machine) implementing the system and method of the present invention;

FIG. 4 shows a specific task recognizer and a decoder module of FIG. 3;

FIG. 5 shows an example of use of an integrator of FIG. 2; and

FIG. 6 is a flow diagram showing the steps implementing the method of the present invention.

### DETAILED DESCRIPTION OF A PREFERRED EMBODIMENT OF THE INVENTION

The present invention is based on the concept that people attending meetings bring laptops or computers to such meetings, each having speech recognition systems installed thereon. Note that not all computers (e.g., processors) run the same speech recognition program. In accordance with the present invention, the computer and more accurately the processor runs an application that allows all of the speech recognition systems to cooperate amongst themselves. A general computer or other like machine may be used to coordinate the laptops.

When each user speaks at the meeting the speech recognition systems, utilizing the method and system of the present invention, cooperate with each other by (i) recognizing their own master and (ii) then sending the decoding to a central server/referee, which is also receiving and evaluating information received from other speech recognition systems. The central server/referee may also be resident on any of the computers. Finally, the speech recognition server chooses the best resulting transcription on the basis of the information that it receives from the many computers present at the meeting.

The present invention also contemplates sending voice data or results of signal processing data from other speech recognition systems to a central server/referee. Therefore, the computers located at a distance from the speaker may also participate in the decoding process. Parallel decoding on several processors improves the algorithms produced from parallel speech recognition systems. One of the methods that allows for improving speech recognition is “Rover”, a voting system that chooses the most frequent set of similar decoded text from many entries by several speech recognition systems. For example, if five speech recognition systems chose one word, and three speech recognitions systems chose another word, then the system assumes that the word chosen by the five machines was the correct word.

By using the system and method of the present invention, every speaker has a processor (in the computer) running a speech recognition system which is capable of:

1. Identifying its “master”, i.e., being able to filter out signals corresponding to a person the laptop is associated with from the environment;

2. Recognizing what the “master” said (possibly with the assistance of topic identification, environment identification, tracking number of speakers present or other techniques); and

3. Presenting to the referee the statement of type: (My master said: “It came with my pea sea”) and associate two scores (both between 0 and 1) with this statement. As an example, these scores may be (i) 0.99 score that it was the computer's “master” who said the statement and (ii) 0.60 score that the statement was recognized correctly.

In embodiments, each computer may receive from the referee feedback about its performance. Also, when not recognizing their “master”, the computer may maintain its own record of speakers and text, and be able to present it to the referee (automatically or upon request by the referee).

The act of a user computer presenting its version of text to the referee is called a “bid”. The referee program is preferably responsible for maintaining a stenographic record of the conversation between the users present at the meeting or other forum. To perform this task, the referee should be able to:

1. Receive “bids” from individual processors;

2. Decide which “bids” will be accepted into official text record (this record is available to participating processors), and what text needs to be corrected; for example, it could accept the claim about the identity of the speaker, but enter a corrected version of the text into the official record;

3. Notify individual processors on disposition of their “bids” and introduced corrections; and

4. Maintain a record of “credibility” of various computers on their ability to recognize their master and the text.

As to the maintenance of the record, this record may be used to adaptively improve the referees performance. For example, the referee could find one of the speech recognition systems so unreliable that it gives the computer using this speech recognition system a credibility index of “0” and puts in its own version of speaker/text, possibly after polling other computers for their version of the speaker/text. In other words, the more accurate interpretations could help the referee to maintain the record, even when some of the interpretations are not very accurate. The credibility record can also be used by individual computers to improve performance

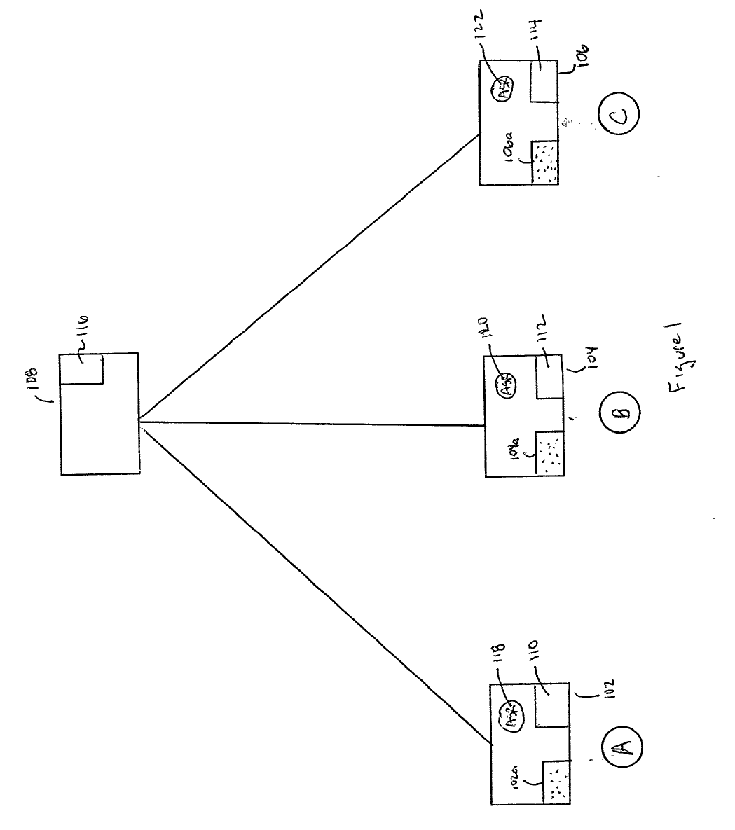

Referring now to the drawings, and more particularly to FIG. 1, there is shown an overview of a system implementing the present invention. In FIG. 1, users “A”, “B” and “C” are associated with central processing units (CPU) 102,104 and 106, respectively. The CPUs 102, 104 and 106 may be implemented in laptop computers, desktop computers or any other finite state machine (hereinafter referred to as computers). It should be readily recognized that the system of the present invention may include two or more users and respective computers depending on the specific implementation of the present invention. Accordingly, the use of three users and respective computers should not be considered a limiting feature of the present invention, and is merely provided for simplicity of discussion herein.

Still referring to FIG. 1, each of the computers 102, 104 and 106 include respective modules 102a, 104a, and 106a. In embodiments, the modules 102a, 104a and 106a represent microphones. A module 108 is connected to each of the computers 102, 104 and 106, preferably via a wireless communication. The module 108 may also be a central processing unit (CPU) (hereinafter referred to as computer) and includes a referee program 116 (discussed below). Note that each of the computers 102, 104 and 106 may also include a referee program. Drivers 110, 112 and 114 are associated with the respective computers 102, 104 and 106 as well as respective automatic speech recognition (ASR) systems 118, 120 and 122. The drivers 110, 112 and 114 provide information to the ASR as well as between computers. These ASR systems may be any known speech recognition system, and may vary from computer to computer.

In use, each of the microphones 102a, 104a and 106a are capable of detecting the voices of each user. For purposes of the present discussion, each microphone 102a, 104a and 106a is capable of detecting each of the voices of users “A”, “B” and “C”; however, it should be understood that the present invention is not limited to such a scenario. For example, in larger rooms and the like only some of the microphones may be able to detect those speakers which are close to that respective microphone, depending on the sensitivity of the microphone. The user is referred to as a master for each computer which is trained to interpret the voice of that particular user. In this case, a respective driver may provide voice data to a remote computer (ASR).

In the situation when all of the microphones are capable of detecting each of the speakers, each computer may then determine from the first computer which user “A”, “B” or “C” is speaking at a specific time. For example, when user “A” is speaking (and users “B” and “C” are silent) the computer 102 determines that user “A” (its master) is speaking, and not users “B” or “C”. Also, computers 104 and 106 are capable of determining that users “B” and “C” are not speaking, but only speaker “A”. This same situation is applicable for the scenarios of when users “B” and/or “C” are speaking. All the computers 102, 104 and 106 may be monitoring whether its master has begun to speak.

It is noted that the microphones 102a, 104a and 106a closer to the speaker typically have a better clarity and increased volume. This better clarity and increased volume is then used by the computers 102, 104 and 106 to determine the approximate distance of the speaker and therefore determine if the speaker is that computer's master (i.e., the user which is associated with that particular computer). If the computer determines that its master is speaking, then the voice in the microphone is sent through another driver from one computer to another (i.e., from computer 102 to 104 to 106). For example, driver 120 receives acoustic data input from microphone 102a and transmits the data to the ASR 122 in computer 104. Similarly, driver 112 may receive acoustic data input from microphone 102a and transmit this data to the ASR in computer 106. Accordingly, when it is determined that another user has begun speaking, the data is sent to the other computers, for example, from user “B” to users “C” and “A”. It is noted that the acoustic data input may be sent to and from each computer through a communication module or through the server 108 Also, each ASR recognizes the voice of its associated user and sends this information to the referee program to produce a better decoding. The method for producing a better decoding is described below.

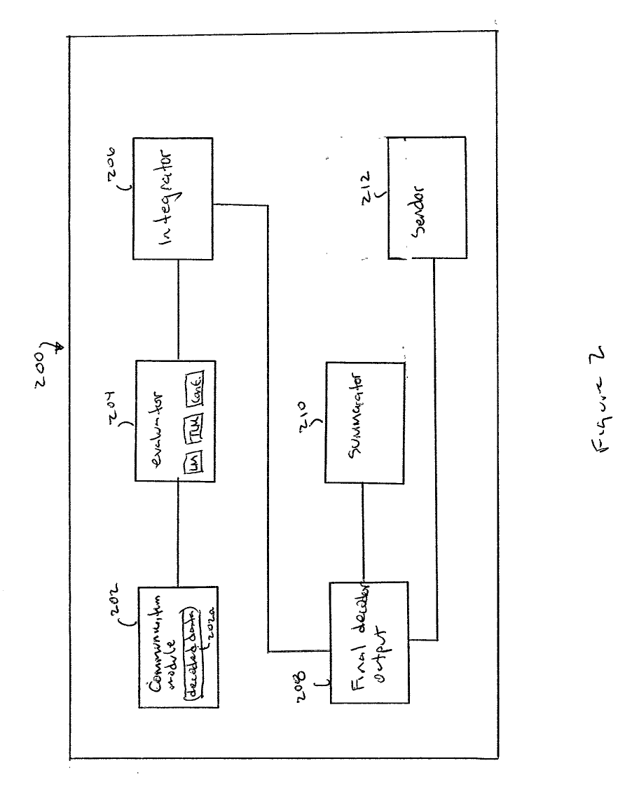

FIG. 2 shows a system diagram of the present invention. FIG. 2 may equally represent a flow chart implementing the steps of the present invention. A communication module 202 receives voice data (acoustic data) from each of the computers 102, 104 and 106. More specifically, the communication module 202 may receive decoding data (voice data), designated 202a, from each of the computers for all of the users, “A”, “B and “C”. The voice data received from each of the computers 102, 104 and 106 may be of the same speaker regardless of whether that speaker was the master speaker for that computer. This allows the system of the present invention to analyze all voice data and determine the most accurate rendition of such data, via a weighted decision. The communication module 202 may be resident on the computers or may be remote from the computers, depending on the specific application of the present invention.

The data, associated with each of the computers 102, 104 and 106, is then sent to an evaluator module 204. The data is then analyzed and receives a confidence score. A likelihood score (i.e., what is the chance that the word was placed correctly) may also be provided. The confidence score may be assigned in the local computers 102, 104 and 106 and may also be sent to the referee program 116. The evaluator of each output can rely on receiving a higher level language model which may be used to determine the chance of each type of text, evaluate the perplexity of a given text, and determine a chance of the proper word being placed correctly amidst the remainder of the text.

The evaluator module 204 may also utilize a weighted system as well as take into account the topic of the language model data used with each ASR system. The weighting of the data may be used to determine the most accurate rendition of the words spoken by each user, “A”, “B” or “C”. For example, it is very likely that the ASR systems of each computer may have different language models, and the ASR of the non-master computer may have a better language model that is also similar to the topic of discussion. In this case, the word that was recognized on the non-master computer (e.g., a computer which received voice data from a user which is not associated with that computer) may have a higher weight than the decoded word from the master computer (e.g., a computer which received voice data from a user which is associated with that computer). For example, the master computer may have a speaker dependent model while the other computers may have speaker independent models, all of which would directly affect the quality of the decoding. By using the weighting, the more accurate rendition of the word interpreted from the non-master computer would then be utilized by the method and system of the present invention.

An integrator module 206 integrates all of the decoder data from all of the ASR systems into one decoding output. Note that it is assumed that the ASR systems for each computer may be different; however, even when there are identical ASR systems, they may have different decoding methods. In this way, each speech recognition produces a text that is variable from the text of other ASR systems. By way of example, a “Rover” method is utilized according to reference number “X”. This is based on a voting system that chooses the word that was chosen by the majority of the ASR systems. The integrator module 206 may use the weight provided by the evaluator 204.

The integrated data is then provided to a final decoder output module 208. The final decoder output module 208 prepares the summary of the entire decoded output of what was spoken, as per reference “X”. This summarized data is sent both the summurator module 210 and the sender module 212. The sender module 212 may send the final decoded data to a computer laptop (if needed) for transcription or editing.

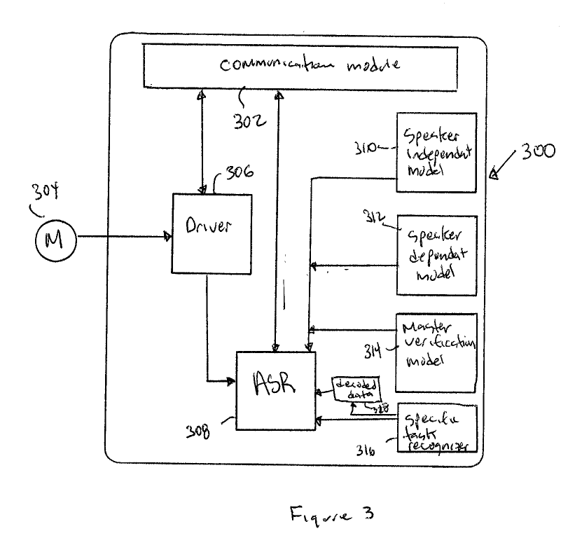

FIG. 3 describes the composition of a computer implementing the system and method described herein. The computer is generally designated as reference numeral 300 and may represent any of the computers shown in FIG. 1. The computer 300 includes a communication module 302 that allows the computer to communicate with the server and other computers. A microphone 304 is connected to a driver 306 which is responsible for sending the voice data from the microphone 304 into the speech recognition module 308 or into the communicator module 302 so that other computers may receive such voice data. The driver 306 is also capable of receiving data from other computers and sending such data to the speech recognition modules (ASR) 308. The ASR 308 may also send decoded data to the communication module 302 or other additional information (likelihood of the word, or information from other decoding modules). The ASR 308 may be connected to different models such as, for example, speaker independent model 310, speaker dependent models 312, master verification model 314 and specific task recognizer module 316. The master verification model 314 checks that the master is speaking. The ASR 308 is also capable of partial decoding and specific task recognition (received from the specific task recognizer module 316) after receiving a partially decoded set of data from the decoder module 318 (of another ASR system on another computer).

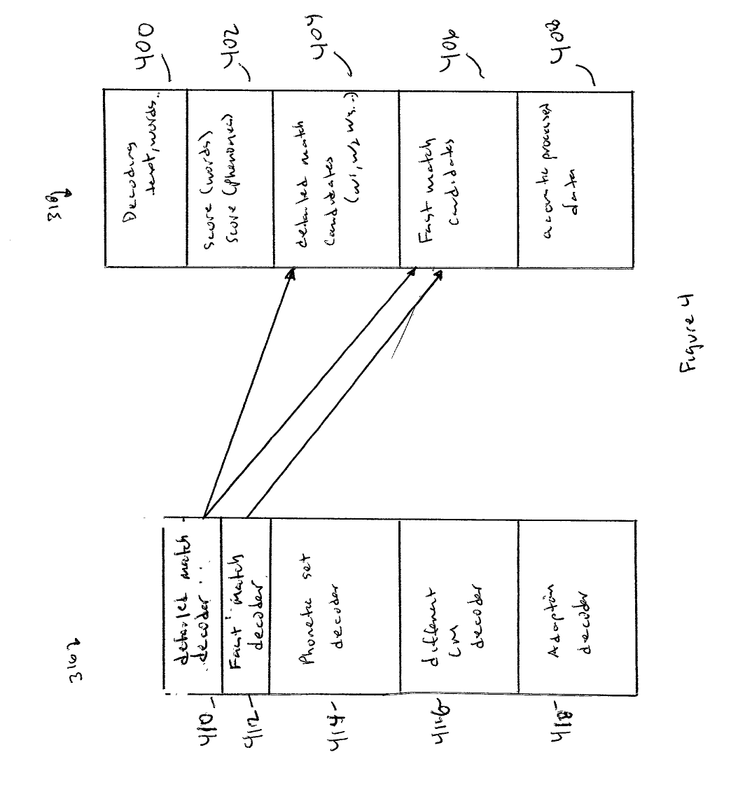

FIG. 4 shows the specific task recognizer 316 and the decoder module 318 of FIG. 3. First, in the decoder module 318, module 400 represents an example of decoded data, e.g., text, words and phonemes. Scores of words and phonemes are represented by module 402 and detailed matching of candidates may be processed in module 404. The module 404 may produce detailed matching of candidates using specific models. It is noted that when time-costly models are being decoded, module 404 is used to produce a detailed list of candidates that may have a high chance of matching a particular set of acoustical data. Several words, e.g., W1, W2, and W3, may comprise any acoustic segment. Module 406 represents the fast matching of candidates composed of words W1 and the lists of words that give an approximate method for finding candidates that are then narrowed by the fast match list. Acoustic data that was already processed by signal processing or by other feature vectors may result from acoustic data module 408 (i.e., any process of speech recognition that results in a form of decoded data may send this data to the other speech recognitions).

Still referring to FIG. 4, the specific task recognizer 316 includes module 410 which performs detailed candidate decoding using the words from modules 404 and 406. The candidates of words received by one speech recognition are sent over to another speech recognition where the present invention provides speech recognition. Similarly, phonetic sets module 414 may be used by the present invention. The phonetic sets may change in each different ASR decoder. Depending on which phonetic set is used, the decoded result may be different. Different language model decoders, and different adaptation modules 416 and 418, may also be used by the present invention. In other words, specific task recognition begins working from the module that represents the type of data that it received. If data was sent after fast matching, then it continues fast match in the present ASR system. If the data was sent after detailed match decoding, it uses the segment of data that was done after detailed match decoding.

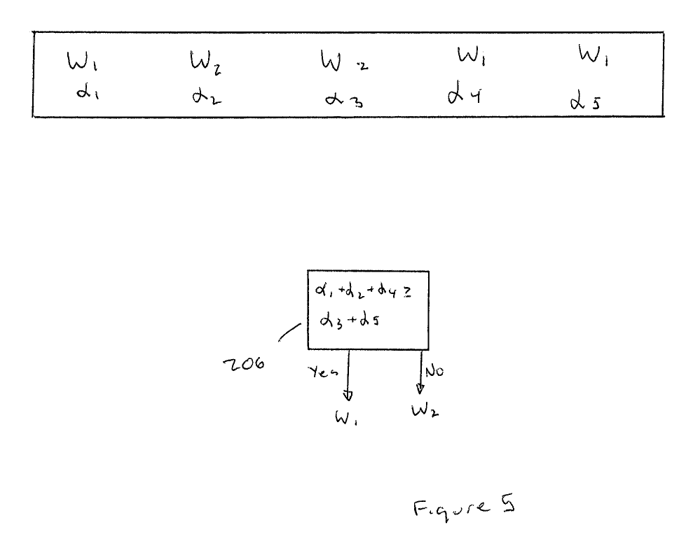

FIG. 5 shows an example of use of the integrator 206 of FIG. 2. Assuming that the integrator 206 received the five words from speech recognition, W1 with weight α1, W1 with weight α2, W2 with weight α3, W1 with weight α4 and W2 with weight α5. The integrator 206 compares if the weights of word W1 (α1+α2+α4) is greater than or equal to the weights of word W2 (α3+α5). If the weight of W1 is greater than or equal to the weight of W2, then the method and system of the present invention assumes that word W1 was said by a user. If not, then the method and system of the present invention decides that word W2 was said by a user. This scheme is one example of how the data may be integrated. Note that α1, α2, α3, α4 and α5 are the weights received from evaluator module 204 of FIG. 2 (which provides the words a confidence score that may be based on topic reference).

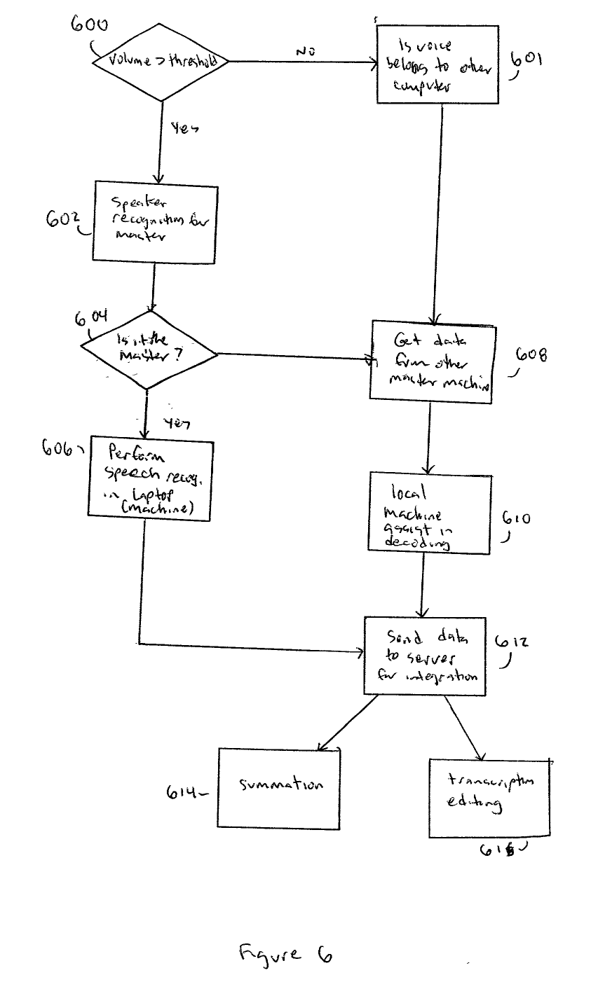

FIG. 6 is a flow diagram showing the steps implementing the method of the present invention. FIG. 6 may equally represent a high level block diagram of the system of the present invention. The steps of FIG. 6 (as well as those shown with reference to FIG. 2) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

In step 600, a determination is made as to whether the volume of the acoustic data is greater than a predetermined set threshold value. If the volume is greater, then in step 602, speaker verification for the master is performed. In step 602, background noise may also be filtered. This background noise does not belong to a speaker. In step 604, a determination is made as to whether the master is speaking. If the master is speaking, in step 606, speech recognition is performed in the laptop (machine) that recognizes its master is speaking. The data is then sent to the server for integration in step 612. The integrator data may then be sent for summation in step 614 or transcription editing on the laptop in step 616.

Referring back to step 600, if the volume of the acoustic data is not greater than a threshold value, in step 601, the method of the present invention checks that the voice data belongs to a master in another computer. Once a determination is made that the voice belongs to a master of another computer, in step 608, the acoustic data is obtained from the other computer. It is noted that if a negative determination is made in step 604, the step 608 will also be performed. After the voice data is received from the master computer, the local machine assists in the decoding of the voice data from the master computer in step 610. The decoded data is then sent to the server for integration in step 612, which may be summarized (step 614) or transcribed for editing (step 616).

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of integrating acoustic data using speech recognition, comprising the steps of:
detecting voice data on a first computer and at least a second computer;
identifying the voice data as a first master speaker associated with a speech recognition system residing on the first computer;
providing the voice data of the first master speaker, from the first computer, to the at least the second computer having a speech recognition system residing thereon;
analyzing the voice data residing on the first computer and the at least the second computer; and
integrating the analyzed voice data from the first computer and the at least the second computer into a single decoding output.

2. The method of claim 1, further comprising the steps of:
detecting a second voice data on the first computer and at least the second computer;
identifying the second voice data as being a second master speaker associated with the speech recognition system of the at least the second computer;
providing the second voice data to the first computer from the at least second computer;
analyzing the second voice data residing on the first computer and the at least the second computer; and
integrating the analyzed voice data and the analyzed second voice data into the single decoding output.

3. The method of claim 2, wherein the at least the second computer is a second and third computer.

4. The method of claim 2, wherein:
the identifying the voice data as the first master speaker comprises the step of determining that a volume of the voice data is higher than a predetermined threshold value associated with the first computer; and
the identifying the second voice data as the second master speaker comprises the step of determining that a volume of the second voice data is higher than the predetermined threshold value associated with the at least the second computer.

5. The method of claim 2, further comprising the step of one of (i) summarizing the analyzed voice data and the second voice into a single transcript and (ii) editing the analyzed voice data and the second voice data.

6. The method of claim 2, wherein:
the analyzed voice data on the first computer is W1 and the analyzed voice data on the at least the second computer is W2; and
the step of analyzing the voice data includes:
providing a weight to the voice data of W1 and the voice data of W2;
comparing the weight of W1 to W2; and
selecting a higher or equal weight of W1 or W2 as a more accurate rendition of the voice data.

7. The method of claim 6, wherein:
the analyzed second voice data on the first computer is W3 and the analyzed voice data on the at least the second computer is W4; and
the step of analyzing the second voice data includes:
weighting the second voice data of W3 and the second voice data of W4;
comparing the weight of W3 to W4; and
selecting a higher or equal weight of W3 or W4 as a more accurate rendition of the second voice data.

8. The method of claim 2, wherein the step of analyzing the voice data and the second voice data residing on the first computer and the at least the second computer includes providing a confidence level to each word associated with both the voice data and the second voice data.

9. The method of claim 2, wherein the first computer and the at least the second computer communicate with one another via a wire or wireless communication protocol.

10. The method of claim 2, wherein:
the speech recognition of the first computer and the at least the second computer are one of (i) a same speech recognition system and (ii) a different speech recognition system; and
the first master speaker and the second master speaker are further associated with the speech recognition of the at least the second computer and the first computer, respectively.

11. The method of claim 2, further comprising the step of filtering out background noise.

12. The method of claim 2, further comprising the step of providing feedback to the first computer and the at least the second computer relating to a performance of the analysis of the first voice data and the second voice data, respectively.

13. The method of claim 2, further comprising the steps of:
maintaining a record of credibility” of the first computer and the at least second computer relating to an ability to recognize a respective master speaker and associated voice data; and
adaptively improving a performance of the speech recognition of the first computer and the at least the second computer in order to improve a performance of the analyzing step.

14. A system for integrating acoustic data using speech recognition, comprising:
a communication module which receives voice data from a plurality of computers each having speech recognition residing thereon, the communication module residing on the plurality of computers or a remote server;
an evaluator module associated with each of the plurality of computers, the evaluator module analyzes the voice data from each of the plurality of computers; and
an integrator module associated with the evaluator module, the integrator module integrates all of the analyzed voice data from each of the plurality of computers and provides one decoding output.

15. The system of claim 14, wherein:
the voice data is associated with at least two master speakers associated with the speech recognition associated with different computers of the plurality of computers; and
the integrator module integrates the voice data of the at least two master speakers into the one decoding output.

16. The system of claim 14, wherein the evaluator module:
provides each word of the analyzed voice data with a weight and a confidence score;
the weight of each word is compared to one another; and
a highest or equal value of the combined weights of the each word is chosen so as to provide a most accurate rendition of the voice data.

17. The system of claim 14, further comprising a master speaker determination module associated with the speech recognition residing on the plurality of computers, the master speaker determination module determining the master speaker associated with the voice data by comparing a volume of the voice data to a threshold value.

18. The system of claim 14, further comprising:
a final decoder output module associated with the integrator module, the final decoder output module prepares a summary of the decoded output;
summurator module for receiving the summary of the decoded output; and
a sender module for sending the decoded output to a computer of the plurality of computers for transcription or editing the decoded output.

19. A machine readable medium containing code for integrating acoustic data using speech recognition, comprising the steps of:
detecting voice data on a first computer and at least a second computer;
identifying the voice data as a first master speaker associated with a speech recognition system residing on the first computer;
providing the voice data of the first master speaker, from the first computer, to the at least the second computer having a speech recognition system residing thereon;
analyzing the voice data residing on the first computer and the at least the second computer; and
integrating the analyzed voice data from the first computer and the at least the second computer into a single decoding output.

20. The machine readable code of claim 19, further comprising the steps of:
detecting a second voice data on the first computer and at least the second computer;
identifying the second voice data as being a second master speaker associated with the speech recognition system of the at least the second computer;
providing the second voice data to the first computer from the at least second computer;
analyzing the second voice data residing on the first computer and the at least the second computer; and
integrating the analyzed voice data and the analyzed second voice data into the single decoding output.
